(19) United States
(12) Patent Application Publication
(10) Pub. No.: US 2022/0258904 A1
(43) Pub. Date: Aug. 18, 2022

(54) ELECTRONIC TAG STICKING APPARATUS

(71) Applicants: DAIO PAPER CORPORATION, Shikokuchuo-shi, Ehime (JP); DAIO ENGINEERING CO., LTD., Shikokuchuo-shi, Ehime (JP)

(72) Inventors: Hirohide OUCHI, Odawara-shi (JP); Kenji HIYOSHI, Odawara-shi (JP); Ryoto TAKAHASHI, Odawara-shi (JP)

(73) Assignees: DAIO PAPER CORPORATION, Shikokuchuo-shi, Ehime (JP); DAIO ENGINEERING CO., LTD., Shikokuchuo-shi, Ehime (JP)

(21) Appl. No.: 17/625,013

(22) PCT Filed: Jul. 10, 2020
(86) PCT No.: PCT/JP2020/027001

§ 371 Date: Jan. 5, 2022

(30) Foreign Application Priority Data
Jul. 17, 2019 (JP) 2019-131967

(51) Int. Cl. B65C 9/26; B65C 9/40

(52) U.S. Cl. CPC B65C 9/26; B65C 2009/0003; B65C 9/40

(57) ABSTRACT

An electronic tag sticking apparatus provided with: a tag feeding device that feeds an electronic tag having an adhesive part to a predetermined tag feeding position P1, a tag holding part that holds the electronic tag, a movement device that moves the tag holding part, and a sticking detection device for detecting that the tag has been stuck onto a target object at a predetermined contact position P3. A preparatory operation is performed such that, after the tag holding part is positioned at the tag feeding position P1 by the movement device and the electronic tag fed from the tag feeding device is held by the tag holding part, the tag holding part holding the electronic tag is moved to a standby position P2 and is caused to stand by so as to be oriented in a direction in which the adhesive part is pressed against the target object.

### TECHNICAL FIELD

The present invention relates to an electronic tag sticking apparatus, the electronic tag having an adhesive part.

### BACKGROUND ART

As is well known, an electronic tag (also referred to as an RF tag, an IC tag, an RF label, or the like) includes an IC chip and an antenna connected to the IC chip for performing storage and reading-out of information in a non-contact manner by near field communication. In addition, typically, the electronic tag has an adhesive surface as a rear surface for sticking to a target object. Radio frequency identification (RFID) is an automatic recognition system that performs writing of individual information of the target object to the electronic tag and reading-out of the individual information of the target object which is stored in the electronic tag through radio communication by using the electronic tag.

Various examinations and suggestions have been made on the electronic tag, and some are realized and some are not realized. For example, the electronic tag is expected to be applied to individual product management of products as an alternative to an optically readable tag such as a barcode, but use in a retail business such as a convenience storage in which a unit price is low is not realized in Japan. The main reason for this is that a unit price of the electronic tag is high, but a reading accuracy related problem (blocking of radio waves due to water contained in the content of the product, a metallic product container, or the like), incompletion of a technology of sticking the electronic tag to individual products, and the like also become a hindrance to spreading.

Of these, with regard to the electronic tag sticking technology to individual products, there is suggested a technology of sticking an electronic tag to which constant information (for example, manufacturing information, track loading information, inventory information, sale information, loss information, delivery information, consumption expiration date information, and consumption information) is written to constant products (for example, refer to Patent Document 1 to Patent Document 5).

However, in order to realize individual product management of products by using a method of sticking the electronic tag to which the constant information is written, source tagging (attachment of the electronic tag to the products by a manufacturer) is necessary for almost all products, and thus it takes a lot of time for improvement of an environment thereof.

Accordingly, in a current state, a retail store desires to stick the electronic tag to individual products. As an electronic tag sticking apparatus suitable to the retail store, for example, an apparatus described in Patent Document 6 is suggested.

However, in the case of sticking the electronic tag at the retail store, it is necessary to reliably stick the electronic tag to products different in a size or a shape, and a package at an appropriate position, but complete automation thereof is difficult. Even if a certain degree of automation is realized, it is difficult to avoid complication of an apparatus and an increase in the cost.

### CITATION LIST

### Patent Document

Patent Document 1: JP-A-2005-104521
Patent Document 2: JP-A-2007-091246
Patent Document 3: JP-A-2007-091298
Patent Document 4: JP-A-2008-044661
Patent Document 5: JP-A-2008-62965
Patent Document 6: Japanese Patent No. 6,484,379

### SUMMARY OF THE INVENTION

### Technical Problem

Here, a main object of the invention is to provide an electronic tag sticking apparatus capable of reliably sticking an electronic tag to a wide variety of products at an appropriate position.

### Solution to Problem

<First Aspect>

An electronic tag sticking apparatus including:

a tag feeding device that feeds an electronic tag having an adhesive part to a predetermined tag feeding position;

a tag holding part that holds the electronic tag;

a movement device that moves the tag holding part to the tag feeding position, and a standby position of standing by sticking of the electronic tag; and

a sticking detection device that detects whether the electronic tag held by the tag holding part has been stuck to the target object held by a worker at a predetermined contact position,

in which a preparatory operation of causing the tag holding part to locate at the tag feeding position by the movement device, causing the tag holding part to hold the electronic tag fed from the tag feeding device, causing the tag holding part holding the electronic tag to move to the standby position, and causing the adhesive part to stand by toward a pushing direction against a target object is performed, and

when detecting that the electronic tag has been stuck to the target object by the sticking detection device, after releasing the electronic tag from the tag holding part, the preparatory operation is performed.

(Operational Effect)

In this electronic tag sticking apparatus, the electronic tag fed from the tag feeding device is conveyed to the tag holding part, is moved to the standby position, and stands by in a state where the adhesive part faces a pushing direction against the target object. Then, when the sticking detection device detects that the electronic tag held by the tag holding part has been stuck to the target object held by a worker, the electronic tag is released from the tag holding part, and sticking of the electronic tag is completed. In this manner, this electronic tag sticking apparatus automates a process of putting the electronic tag in a state suitable for sticking, and entrusts positioning of sticking to the worker while reducing the work. According to this, the electronic tag can be reliably stuck to a wide variety of products at an appropriate position. Particularly, in a retail store, the worker frequently handles products by hands at the time of carrying in the products, and thus it can be said that the invention is suitable for the partial automation.

<Second Aspect>

The electronic tag sticking apparatus according to the first aspect,

in which a position of the electronic tag at the standby position is a contact position at which the electronic tag is stuck to the target object,

the sticking detection device detects that the target object has been disposed at the contact position, and

when detecting that the target object has been disposed at the contact position by the sticking detection device, the electronic tag is released from the tag holding part.

(Operational Effect)

In this electronic tag sticking apparatus, the worker sticks the electronic tag to the target object by pressing the target object against the electronic tag located at the standby position. In this case, when pressing the target object against the electronic tag located at the standby position, the target object is disposed at the contact position, and thus when detecting this situation by the sticking detection device, the electronic tag is released from the tag holding part. In this electronic tag sticking apparatus, the entirety of a sticking operation is performed by the worker, and thus the electronic tag can be reliably stuck to a wide variety of products at an appropriate position.

<Third Aspect>

The electronic tag sticking apparatus according to the first aspect,

in which the position of the electronic tag at the standby position is spaced apart from a contact position at which the electronic tag is stuck to the target object,

a target object detection device that detects that the target object has been disposed at the contact position is provided,

the sticking detection device detects that the electronic tag has been moved to the contact position,

when detecting that the target object has been disposed at the contact position by the target object detection device, the tag holding part is moved by the movement device, and the electronic tag held by the tag holding part is moved to the contact position, and

when detecting that the electronic tag has been moved to the contact position by the sticking detection device, the electronic tag is released from the tag holding part.

(Operational Effect)

In this electronic tag sticking apparatus, when the worker puts the target object at the contact position, this situation is detected, the electronic tag located at the standby position is moved up to the contact position, and is pressed against the target object to be stuck thereto. In this case, when detecting that the electronic tag has been moved to the contact position, sticking is completed. Accordingly, when detecting this situation by the sticking detection device, the electronic tag is released from the tag holding part. In this electronic tag sticking apparatus, pushing of the electronic tag is performed by the movement device, and the worker supports the target object, and thus the labor of the worker is less.

<Fourth Aspect>

The electronic tag sticking apparatus according to any one of the first to third aspects,

in which a positioning body configured to push the target object to be positioned at the contact position is provided at the periphery of the contact position.

(Operational Effect)

In this electronic tag sticking apparatus, the worker sticks the electronic tag with the target object held by hands. Accordingly, when aligning the target object with the contact position with the electronic tag, there is a concern that work of disposing the target object at the contact position with the electronic tag or of retaining the disposition may be difficult without any support. In contrast, in this electronic tag sticking apparatus, it is possible to dispose the target object at the contact position with the electronic tag or it is possible to retain the disposition only by pushing the target object against the positioning body without any consciousness, and thus the sticking work becomes easy.

<Fifth Aspect>

The electronic tag sticking apparatus according to any one of the first to fourth aspects, further including:

an aligner that aligns the contact position of the electronic tag with a desired portion in the target object.

(Operational Effect)

In this electronic tag sticking apparatus, the worker sticks the electronic tag with the target object held by hands, and even when the sticking position of the electronic tag in the target object can be freely adjusted by the worker, there is a concern that work of aligning the contact position of the electronic tag with a desired portion in the target object becomes difficult without any guideline. In contrast, in this electronic tag sticking apparatus, since the aligner is provided, the work of aligning the contact position of the electronic tag with the desired portion in the target object becomes easy.

<Sixth Aspect>

The electronic tag sticking apparatus according to any one of the first to fifth aspects,

in which the electronic tag is held by the tag holding part so that the adhesive part faces downward at the standby position and the contact position, and

the worker raises the target object from a lower side of the electronic tag to the contact position to perform sticking.

(Operational Effect)

When performing the sticking work at the above-described disposition, since both the electronic tag and the target object are easy to be visually recognized to the worker, and thus workability is improved.

### Advantageous Effects of the Invention

According to the invention, there is an advantage that an electronic tag can be reliably stuck to a wide variety of products at an appropriate position.

### BRIEF DESCRIPTION OF THE DRAWINGS

FIG. 1 is a perspective view illustrating an electronic tag sticking apparatus.

FIG. 2 is a perspective view illustrating the electronic tag sticking apparatus.

FIG. 3 is a side view illustrating the electronic tag sticking apparatus.

FIG. 4 is a plan view illustrating the electronic tag sticking apparatus.

FIG. 5 illustrates an example of an electronic tag, in which (a) is a plan view, (b) is a side view, and (c) is a bottom view.

FIG. 6 illustrates an example of the electronic tag, in which (a) is a plan view, (b) is a side view, and (c) is a bottom view.

FIG. 7 is a perspective view illustrating an electronic tag stuck target object.

FIG. 8 is a perspective view illustrating an electronic tag stuck target object.

FIG. 9 is an enlarged perspective view illustrating a main portion of the electronic tag sticking apparatus.

FIG. 10 is an enlarged perspective view illustrating the main portion of the electronic tag sticking apparatus.

FIG. 11 is an enlarged perspective view illustrating the main portion of the electronic tag sticking apparatus.

FIG. 12 is an enlarged side view illustrating a main portion of the electronic tag sticking apparatus.

FIG. 13 is an enlarged side view illustrating the main portion of the electronic tag sticking apparatus.

FIG. 14 is an enlarged side view illustrating the main portion of the electronic tag sticking apparatus.

FIG. 15 is an enlarged side view illustrating the main portion of the electronic tag sticking apparatus.

FIG. 16 is an enlarged side view illustrating the main portion of the electronic tag sticking apparatus.

### MODE FOR CARRYING OUT THE INVENTION

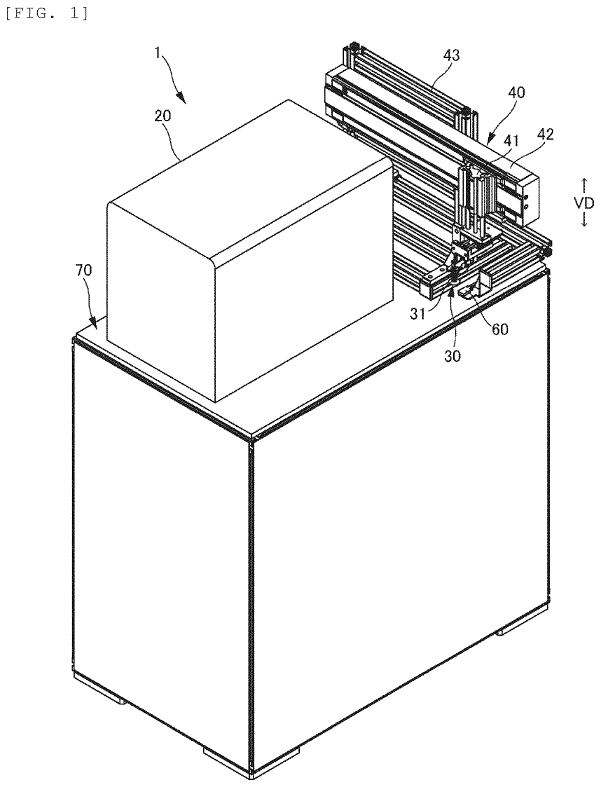

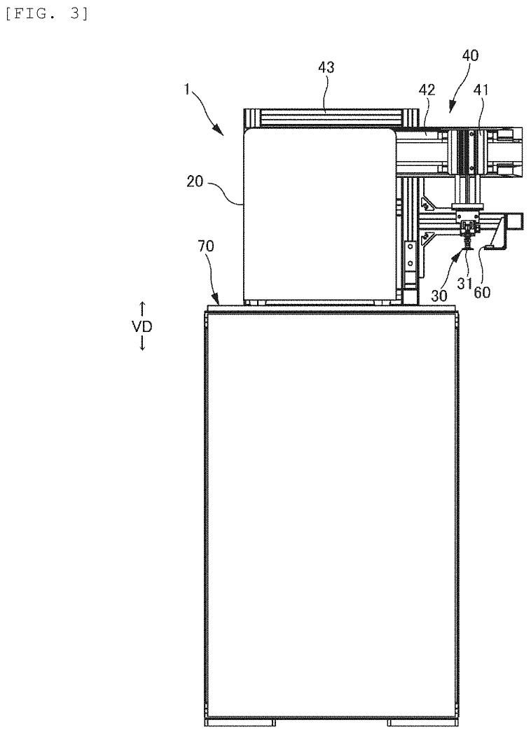

Hereinafter, an example of an electronic tag sticking apparatus 1 will be described. FIG. 1 to FIG. 4 illustrate one example of the electronic tag sticking apparatus 1. The electronic tag sticking apparatus 1 includes a tag feeding device 20 that feeds an electronic tag 10 having an adhesive part 11 to a predetermined tag feeding position P1, a tag holding part 30 that holds the electronic tag 10, a movement device 40 that moves the tag holding part 30 to the tag feeding position P1 and a standby position P2 of standing by sticking of the electronic tag 10, and a sticking detection device 60 that detects that the electronic tag 10 held by the tag holding part 30 has been stuck to a target object 50 held by a worker at a predetermined contact position P3. In use, the following preparatory operation is performed. Specifically, the tag holding part 30 is caused to locate at the tag feeding position P1 by the movement device 40, the tag holding part 30 is caused to hold the electronic tag 10 fed from the tag feeding device 20, the tag holding part 30 holding the electronic tag 10 is caused to move to the standby position P2, and the adhesive part 11 is caused to stand by toward a pushing direction against the target object 50. When detecting that the electronic tag 10 has been stuck to the target object 50 by the sticking detection device 60, after releasing the electronic tag 10 from the tag holding part 30, the preparatory operation is performed.

Hereinafter, respective parts will be sequentially described.

(Target Object)

A shape, a material, and the like of the target object are not particularly limited as long as the target object is an electronic tag sticking target. For example, the target object may be items (may be packaged by a box, a bag, a container, or the like or may not be packaged) handled individually such as an individual product displayed in a store, or may be in a state where one or a plurality of the same or different items are packaged with a packaging material such as a corrugated cardboard box for transportation.

(Electronic Tag)

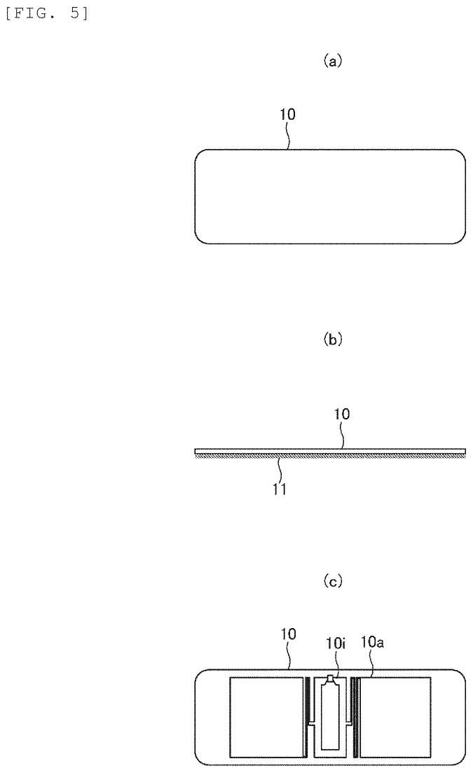

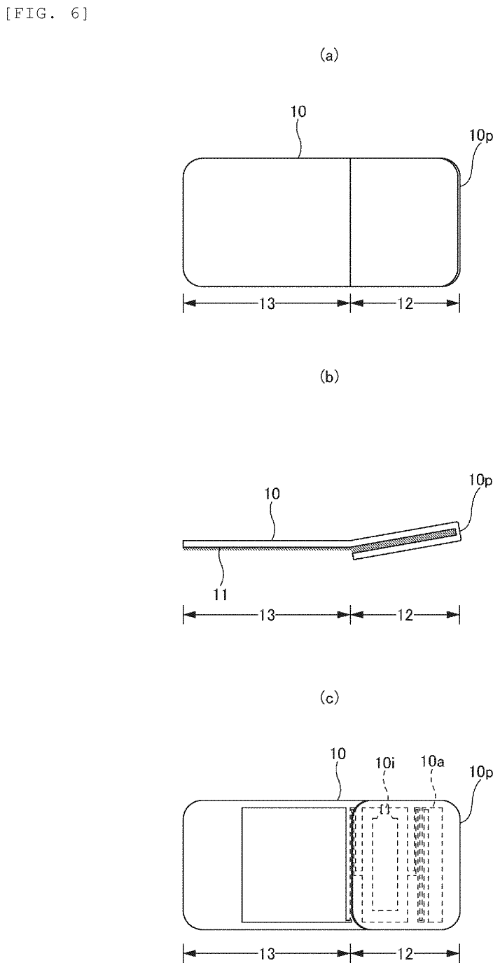

A shape and a structure of the electronic tag 10 are not particularly limited as long as the electronic tag 10 has the adhesive part 11 and is stuck to the target object 50 with the adhesive part 11, and a known electronic tag 10 can be appropriately used. For example, the shape of the electronic tag 10 is, typically, a rectangular shape having corners as illustrated in examples illustrated in FIGS. 5(a) to 5(c), or examples illustrated in FIGS. 6(a) to 6(c), but the shape is not limited thereto. In addition, a representative one of the electronic tag 10 is a passive type electronic tag 10 including an IC chip 10i as inlets 10a and 10i and an antenna 10a connected thereto, for example, as illustrated in FIGS. 5(c) and 6(c), but there is no limitation thereto.

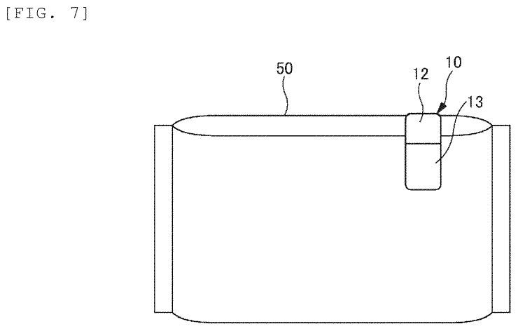

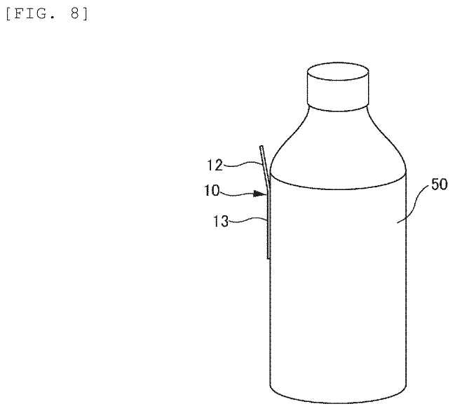

In the electronic tag 10, it is preferable that at least apart of the antenna 10a is spaced apart from the target object 50 so as to prevent deterioration of communication quality. For example, in the case of the electronic tag 10 of which a rear surface is the adhesive part 11, as illustrated in FIGS. 6(a) to 6(c), a part of the electronic tag 10 which includes the antenna 10a is folded at a folding position 10p to form a non-adhesive portion 12 in which parts of the adhesive part 11 are stuck, and a residual adhesive portion 13 in which the adhesive part 11 is exposed, and the electronic tag 10 can be stuck to the target object 50 with the adhesive part 11 in the residual adhesive portion 13 as illustrated in FIG. 7 and FIG. 8. Folding of the electronic tag 10 may be performed by a mechanism inside a tag feeding device (for example, refer to Patent Document 5), and the electronic tag 10 of which a part is folded in advance may be supplied to the tag feeding device.

(Tag Feeding Device)

As the tag feeding device 20, any device capable of feeding the electronic tag 10 to the predetermined tag feeding position P1 (discharge port) sheet by sheet, and capable of conveying the electronic tag 10 to the tag holding part 30 to be described later in a state where the adhesive part 11 is exposed can be used without particular limitation. For example, as the tag feeding device 20, a device described in Patent Document 6 can be used, and a commercially available device can also be used. As the commercially available device, for example, as in a label printer “Scantronics CL4NX-J series” manufactured by SATO HOLDINGS CORPORATION, or the like, a device that peels off only one sheet of the electronic tag 10 (label) from a release sheet (mount), stands by in a state where the peeled electronic tag 10 protrudes from a device front surface or the like to a predetermined direction such as a forward side, and stands by in a state where only one sheet of the subsequent electronic tag 10 protrudes whenever the protruding electronic tag 10 is removed can be suitably used.

In the illustrated example, it is assumed that the tag feeding device 20 is a desktop type placed on an upper plate of a pedestal 70, but there is no limitation thereto.

(Writing Information)

This electronic tag sticking apparatus 1 may stick the electronic tag 10 to which information is not written to the target object 50, or may stick the electronic tag 10 to which information is written to the target object 50. In the latter case, the electronic tag 10 to which information is written in advance may be set to the tag feeding device 20, or information can also be written to the electronic tag 10 in an appropriate stage in this electronic tag sticking apparatus 1, for example, within the tag feeding device 20, or in a movement step up to the standby position P2 to be described later as in a configuration described in Patent Document 6. In the latter case, as in a configuration described in Patent Document 6, an information acquisition unit that acquires writing information relating to the target object 50 associated with the electronic tag 10, and a writing device that writes the writing information acquired by the information acquisition unit to the electronic tag 10 can be provided. In this case, a part or the entirety of the writing information of the electronic tag 10 can be set as primary information (for example, information applied to the target object 50 as one-dimensional code or two-dimensional code, or characters, figures, or the like as is through printing or the like) that can be acquired from the target object 50.

The writing information of the electronic tag 10 is not particularly limited, but the writing information is, for example, information relating to the target object 50 associated with the electronic tag 10 and can include another information in correspondence with the target object 50. In this case, it is preferable that the writing information includes a part or the entirety of individual information of the target object 50. The individual information includes both identification information for identifying the target object 50 from another object and attribute information representing characteristics, properties, or the like of the target object 50 although the target object 50 cannot be identified from the other object. Examples of the identification information include a product code such as JAN (EAN), UPC, ISBN, GTIN, and ASIN, a serial number, a model number, and a lot number. In addition, examples of the attribute information include a color of a product or packaging, a product weight, and the like in addition to information other than a trademark such as a shipping order, a manufacturing date, a consumption expiration date, and a product name. In addition, the writing information may include accessary information other than the identification information and the attribute information. Examples of the accessary information include time information of time or the like necessary for manufacturing, temperature information of a temperature or the like at the time of manufacturing, humidity information of humidity or the like at the time of manufacturing, and random number information relating to fortune telling and lottery.

(Tag Holding Part)

As long as the tag holding part 30 holds the electronic tag 10 to be movable, and can release the holding after sticking the electronic tag 10 to the target object 50, the tag holding part 30 may have a structure that mechanically holds a non-adhesive part or the like. However, a suction part that suctions an object through air suction is preferable from the viewpoint that holding and release of the electronic tag 10 become reliable. Note that, the tag holding part 30 in the illustrated example is a suction device including a rubber cup 31 and a suction device (not illustrated) that suctions the inside of the rubber cup 31, and performs suction by suctioning air inside the rubber cup 31 while bringing the rubber cup 31 into contact with the non-adhesive surface of the electronic tag 10. However, there is no limitation thereto, and a known structure and a known material can be employed. Note that, the release of the electronic tag 10 in the suction device includes stoppage of suction, ejection of air on the contrary, and weakening of suction to make the electronic tag 10 peelable.

(Tag Holding Detection Device)

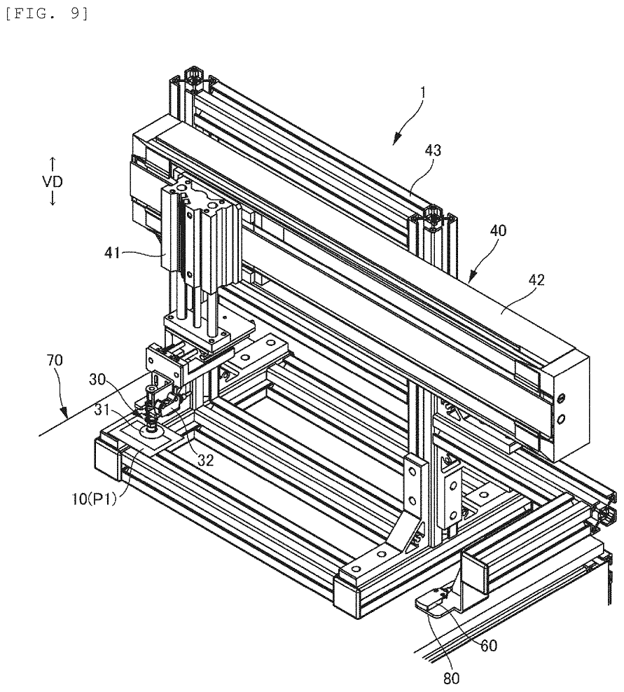

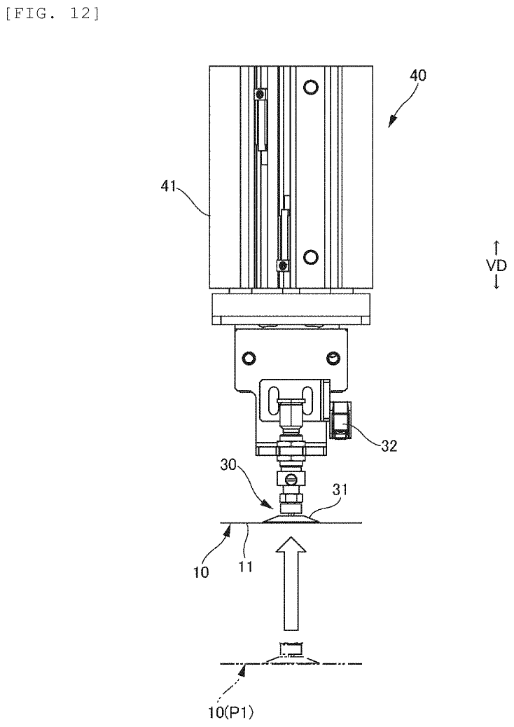

It is preferable to include a tag holding detection device 32 (refer to FIG. 9, FIG. 12, and the like) that detects holding and non-holding of the electronic tag 10 in the tag holding part 30. For example, in addition to a known non-contact type sensor such as a transmission type sensor and a reflection type sensor (illustrated example), a known contact type sensor may be attached to the tag holding part 30 to detect the electronic tag 10 itself as the tag holding detection device 32. In addition, in a case where the tag holding part 30 is the above-described suction device, a pressure sensor can be provided in an air suction system as the tag holding detection device 32. In accordance with a measurement result of the pressure sensor, a case where a pressure value is greater than or equal to a predetermined suction pressure can be detected as a holding state of the electronic tag 10, and a case where the pressure value is less than the suction pressure (for example, the atmospheric pressure) can be detected as a non-holding state of the electronic tag 10. Of course, the former sensor and the latter sensor may be combined.

(Movable Device)

The movement device 40 moves the tag holding part 30 to the tag feeding position P1 and the standby position P2 of standing by sticking of the electronic tag 10. As to be described later, in the case of moving the tag holding part 30 toward the target object 50 when sticking the electronic tag 10 to the target object 50, the movement is also necessary to be possible. As the movement device 40, the movement device in the illustrated example is also preferable as a non-expensive device in addition to various robots as described in Patent Document 6.

That is, with regard to the movement device 40, it is assumed that the tag feeding device 20 that causes the electronic tag 10 to protrude laterally with respect to the tag feeding position P1 with the adhesive part 11 facing downward is installed on the pedestal 70, and the standby position P2 is set to be sufficient high on a lateral side of the pedestal 70. The movement device 40 includes an elevation cylinder 41 that supports the tag holding part 30 to vertically ascend and descend in a vertical direction VD, and a lateral movement cylinder 42 that supports the elevation cylinder 41 to reciprocate in a horizontal direction, and the lateral movement cylinder 42 is supported by a frame 43 installed on the pedestal 70.

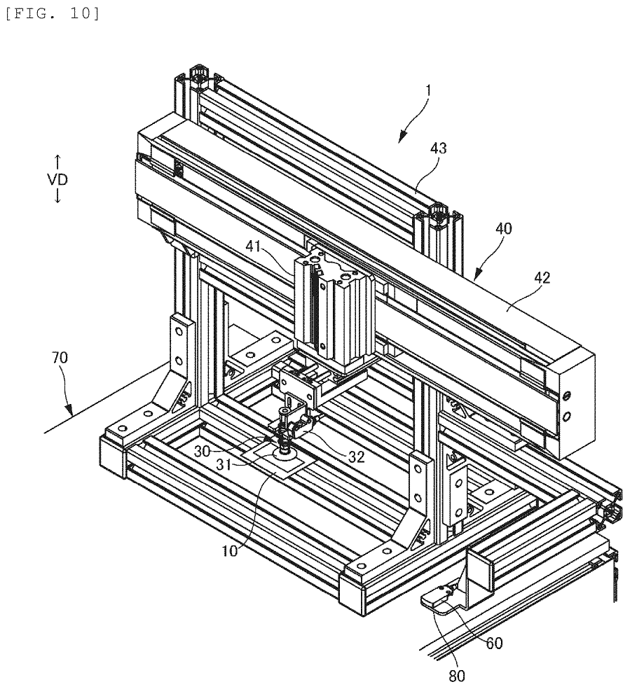

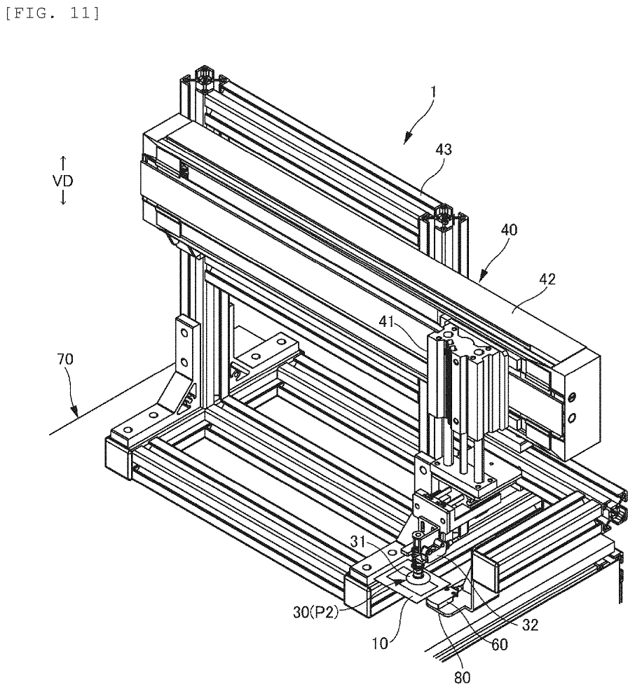

As illustrated in FIG. 9, the tag holding part 30 is located over the tag feeding position P1 at one movement end of the tag holding part 30 by the lateral movement cylinder 42, and at the position, the tag holding part 30 is caused to descend to a predetermined height by the elevation cylinder 41. According to this, the tag holding part 30 (in the illustrated example, the downward rubber cup 31) is brought into contact with the electronic tag 10 located at the tag feeding position P1, and thus the electronic tag 10 can be held by the tag holding part 30. Next, as illustrated in FIG. 12, when the tag holding part 30 holding the electronic tag 10 is caused to ascend by the elevation cylinder 41, the electronic tag 10 is completely peeled off from the tag feeding device 20, and conveyance with respect to the tag holding part 30 is completed. Next, as illustrated in FIG. 10, the tag holding part 30 is moved to the other movement end by the lateral movement cylinder 42, and at the other movement end of the tag holding part 30 by the lateral movement cylinder 42, as illustrated in FIG. 11, the tag holding part 30 is located over the standby position P2 and a contact position P3, and at the position, the tag holding part 30 is caused to descend by the elevation cylinder 41 to a predetermined height to move the tag holding part 30 to the standby position P2. A position where the elevation cylinder 41 is not caused to descend may also be referred to as the standby position P2. Anyway, at the standby position P2 and the contact position P3, the electronic tag 10 is held by the tag holding part 30 so that the adhesive part 11 faces downward. After the electronic tag 10 is stuck to the target object 50, the tag holding part 30 can be returned to the tag feeding position P1 by an inverse operation.

(Pushing Direction)

A pushing direction of the electronic tag 10 and the target object 50, that is, a direction of the adhesive part 11 at the time of sticking is not particularly limited. In the illustrated example, the adhesive part 11 of the electronic tag 10 faces downward at the standby position P2, and when a worker presses the target object 50 against the electronic tag 10 while raising the target object 50 to an upward side, the electronic tag 10 is pressed against the target object 50 due to descent of the elevation cylinder 41, and thus the pushing direction becomes the vertical direction VD. However, when the movement device 40 is configured so that the adhesive part 11 of the electronic tag 10 faces upward or downward at the standby position P2, the pushing direction can also be set to a lateral direction or a downward direction.

(Standby Position and Contact Position)

The position of the electronic tag 10 when the tag holding part 30 is located at the standby position P2, and the contact position P3 at which the electronic tag 10 is stuck to the target object 50 may be the same as each other or different from each other.

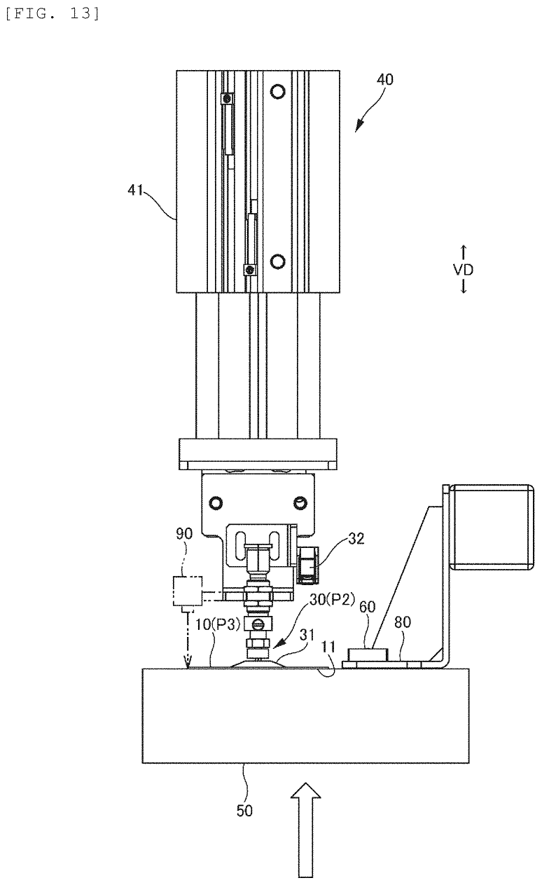

As illustrated in FIG. 13, in a case where the position of the electronic tag 10 when the tag holding part 30 is located at the standby position P2 is set as the contact position P3, a worker presses the target object 50 against the electronic tag 10 located at the standby position P2 to stick the electronic tag 10 to the target object 50. In this case, since the entirety of the sticking operation is performed by the worker, the electronic tag 10 can be reliably stuck to a wide variety of products at an appropriate position.

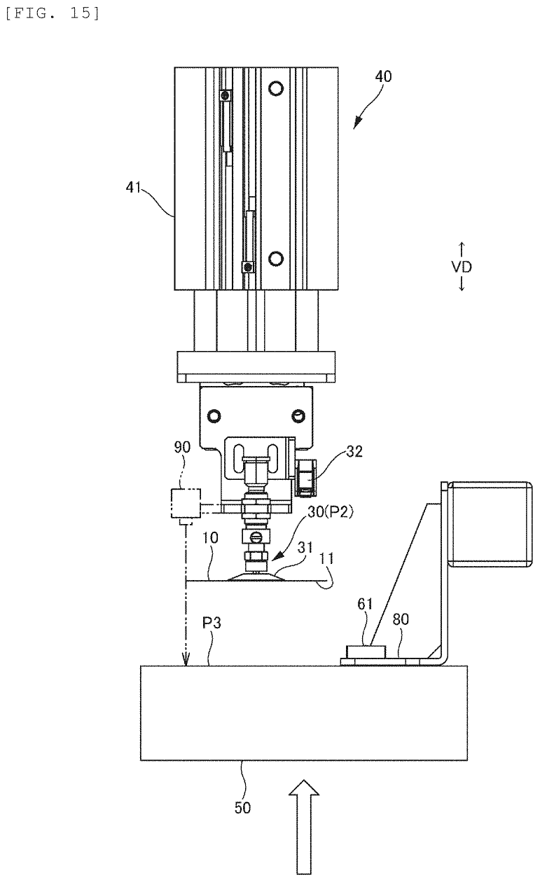

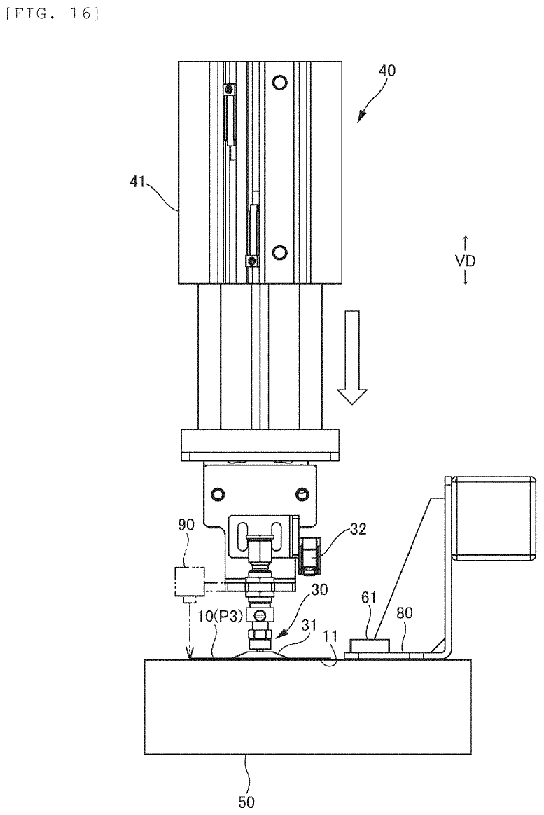

As illustrated in FIG. 15, in a case where the position of the electronic tag 10 when the tag holding part 30 is located at the standby position P2 is spaced apart from the contact position P3 at which the electronic tag 10 is stuck to the target object 50, as illustrated in FIG. 16, the tag holding part 30 located at the standby position P2 is moved by the movement device 40, and the electronic tag 10 held by the tag holding part 30 is moved to the contact position P3 and is pressed against the target object 50 to be stuck thereto. For example, in a case where the standby position P2 is set to a slightly upper side of the contact position P3 in the illustrated example, the tag holding part 30 located at the standby position P2 is caused to descend by the elevation cylinder 41, and the electronic tag 10 is moved up to the contact position P3 and is pressed against the target object 50 to be stuck thereto. In this manner, when the electronic tag 10 is pushed by the movement device 40, and the worker supports the target object 50, the labor of the worker becomes less.

A specific standby position P2 and the contact position P3 at which the electronic tag 10 is stuck to the target object can be appropriately determined. In the illustrated example, the tag feeding device 20 and the movement device 40 are installed on the pedestal 70, and the standby position P2 is set to a lateral side of the pedestal 70, but may be an upward side of the pedestal 70 or the inside of the pedestal 70.

(Sticking Detection Device)

The sticking detection device 60 is not particularly limited as long as the sticking detection device 60 is configured to detect that the electronic tag 10 held by the tag holding part 30 has been stuck to the target object 50 held by the worker at the predetermined contact position P3. In a case where the position of the electronic tag 10 when the tag holding part 30 is located at the standby position P2 is set as the contact position P3, the sticking detection device 60 can detect that the target object 50 has been disposed at the contact position P3. That is, when pressing the target object 50 against the electronic tag 10 located at the standby position P2, since the target object 50 is disposed at the contact position P3, this situation is detected as completion of sticking by the sticking detection device 60, and the electronic tag 10 is released from the tag holding part 30. As the sticking detection device 60 in this case, in addition to a known non-contact type sensor such as a transmission type sensor and a reflection type sensor (illustrated example) that detects the target object 50, a known contact type sensor such as a limit switch can be mounted to the pedestal 70.

As illustrated in FIG. 15 and FIG. 16, in a case where the position of the electronic tag 10 when the tag holding part 30 is located at the standby position P2 is spaced apart from the contact position P3 at which the electronic tag 10 is stuck to the target object 50, a target object detection device 61 configured to detect that the target object 50 is disposed at the contact position P3 is provided, and the sticking detection device is set to detect that the electronic tag 10 is moved to the contact position P3. When the target object detection device 61 detects that the target object 50 is disposed at the contact position P3, the tag holding part 30 is moved by the movement device 40, and the electronic tag 10 held by the tag holding part 30 is moved to the contact position P3. When the sticking detection device detects that the electronic tag 10 is moved to the contact position P3, the electronic tag 10 may be released from the tag holding part 30 as completion of sticking. As the target object detection device 61 in this case, in addition to a known non-contact type sensor such as a transmission type sensor and a reflection type sensor (illustrated example) that detect the target object 50, a known contact type sensor such as a limit switch can be mounted to the pedestal 70. In addition, various sensors similar to the target object detection device 61 are used as the sticking detection device in this case to detect the position of the electronic tag 10 or the tag holding part 30. In addition to this, movement control by the movement device 40 can also be detected in a software manner or a hardware manner (illustrated example).

(Flow of Operation)

In this electronic tag sticking apparatus 1, the electronic tag 10 fed from the tag feeding device 20 is conveyed to the tag holding part 30, is moved to the standby position P2, and stands by in a state where the adhesive part 11 faces the pushing direction against the target object 50. Then, when the sticking detection device 60 detects that the electronic tag 10 held by the tag holding part 30 has been stuck to the target object 50 held by a worker, the electronic tag 10 is released from the tag holding part 30, and sticking of the electronic tag 10 is completed. In this manner, this electronic tag sticking apparatus 1 automates a process of putting the electronic tag 10 in a state suitable for sticking, and entrusts positioning of sticking to a worker while reducing the work. According to this, the electronic tag 10 can be reliably stuck to a wide variety of products at an appropriate position. Particularly, in a retail store, the worker frequently handles products by hands at the time of carrying in the products, and thus it can be said that the invention is suitable for the partial automation.

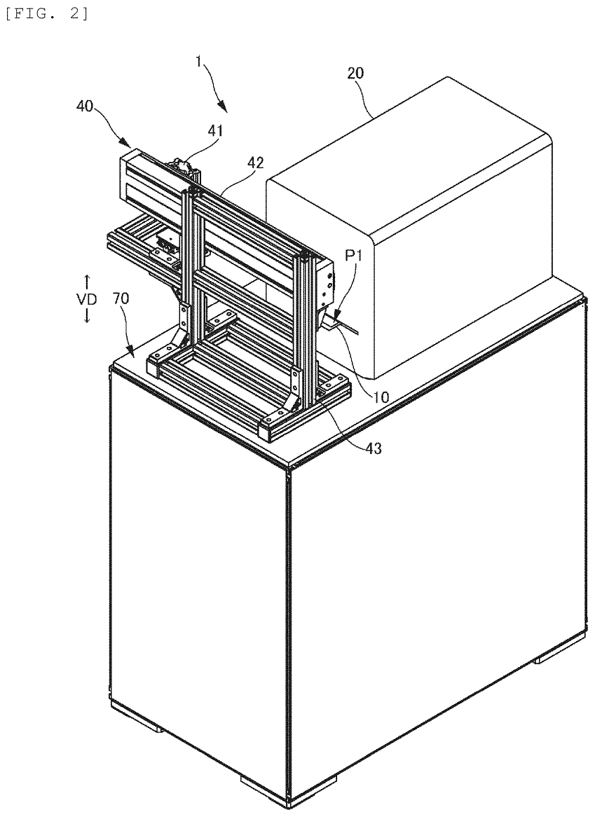

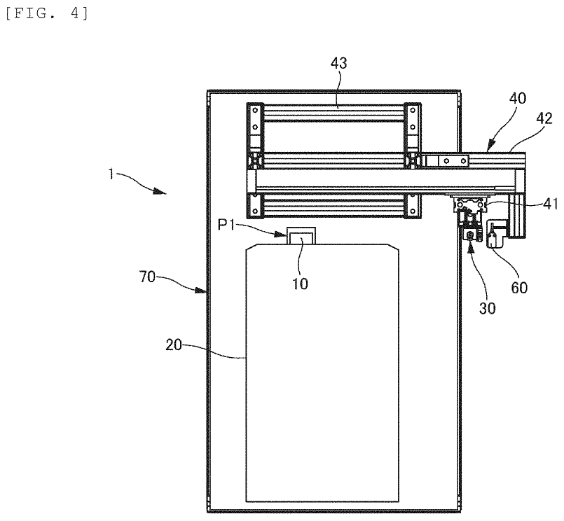

The illustrated example will be described in more detail. That is, as illustrated in FIG. 2 and FIG. 4, the tag feeding device 20 installed on the pedestal 70 stands by in a state where only one sheet of the electronic tag 10 laterally protrudes to the tag feeding position P1. Then, the movement device 40 is driven, and the tag holding part 30 is brought into contact with the electronic tag 10 located at the tag feeding position P1 as illustrated in FIG. 9 due to lateral movement by the lateral movement cylinder 42 and the subsequent descent of the elevation cylinder 41 to a predetermined height, and the electronic tag 10 is suctioned to a tip end of the tag holding part 30 due to suction. When the tag holding detection device 32 detects holding of the electronic tag 10, suction in a suction system is stopped to enter a suction stoppage state, and the movement device 40 is driven. The electronic tag 10 is completely peeled off from the tag feeding device 20 due to ascent of the elevation cylinder 41 up to a predetermined height as illustrated in FIG. 12. Then, as illustrated in FIG. 10, the tag holding part 30 is moved to an upward side of the standby position P2 on a lateral side of the pedestal 70 due to lateral movement by the lateral movement cylinder 42. Continuously, as illustrated in FIG. 11, the tag holding part 30 is moved to the standby position P2 due to descent of the elevation cylinder 41 up to a predetermined height, and a preparatory operation is completed. At a point of time at which the electronic tag 10 is conveyed to the tag holding part 30, the tag feeding device 20 feeds the subsequent electronic tag 10 to the tag feeding position P1 as the subsequent preparatory operation.

At the standby position P2, the electronic tag 10 is held by the tag holding part 30 so that the adhesive part 11 faces downward on a lateral side of the pedestal 70. Accordingly, as illustrated in FIG. 13, a worker can stick the electronic tag 10 to the target object 50 by raising and pressing the target object 50 from a lower side of the electronic tag 10 up to the contact position P3 as indicated by a white arrow. When performing the sticking work in such an arrangement, since both the electronic tag 10 and the target object 50 are easy to be visually recognized to the worker, workability is improved.

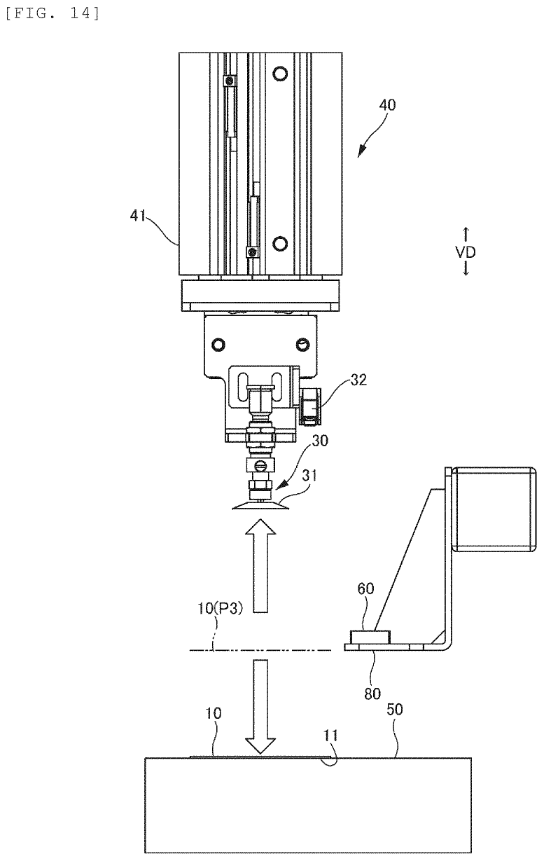

When pressing the target object 50 against the electronic tag 10, the target object 50 is disposed at the contact position P3, and this situation is detected by the sticking detection device 60 as completion of sticking, suction of the tag holding part 30 is released (vacuum disappears), and thus the electronic tag 10 is released from tag holding part 30. According to this, the worker can make a preparation for the subsequent target object 50 after removing the target object 50 from the sticking position. When the target object 50 is removed from the contact position P3, since the target object 50 is not detected by the sticking detection device 60 (a detection signal is turned off), by using this situation as a trigger or after passage of constant time from detection of the target object 50 by the sticking detection device 60, ascent of the tag holding part 30 (FIG. 14) is initiated by the elevation device, the tag holding part 30 is returned to the tag feeding position P1 by an inverse operation, and a preparatory operation is performed again. This repeats itself afterwards.

In the method, a pushing force at the time of sticking depends on the worker. Accordingly, as an approximately the same device configuration, the standby position P2 is spaced apart to an upward side of the contact position P3 as illustrated in FIG. 15, and the pushing at the time of sticking can also be performed by using a driving force of the movement device 40 as illustrated in FIG. 16. In this case, as illustrated in FIG. 15, the worker disposes the target object 50 to the contact position P3 from a lower side as indicated by a white arrow, and when this situation is detected by the target object detection device 61, as indicated by a white arrow in FIG. 16, the tag holding part 30 located at the standby position P2 descends by the elevation cylinder 41, and the electronic tag 10 descends up to the contact position P3 and is pressed against the target object 50 to be stuck thereto. At this time, when the sticking detection device (not illustrated) detects that the electronic tag 10 descends up to the contact position P3, suction of the tag holding part 30 is released (vacuum disappears), and the electronic tag 10 is released from the tag holding part 30. The worker can make a preparation for the subsequent target object 50 after removing the target object 50 from the sticking position. The other configurations are similar to a case where the worker presses the target object 50 against the electronic tag 10 in a standby state.

(Positioning Body)

In this electronic tag sticking apparatus 1, the worker sticks the electronic tag 10 with the target object 50 held by hands. Accordingly, when aligning the target object 50 with the contact position P3 with the electronic tag 10, there is a concern that work of disposing the target object 50 at the contact position P3 with the electronic tag 10 or of retaining the disposition may be difficult without any support. Here, it is preferable that a positioning body 80 configured to push the target object 50 to be positioned at the contact position P3 is provided at the periphery of the contact position P3. In this case, it is possible to dispose the target object 50 at the contact position P3 with the electronic tag 10 or it is possible to retain the disposition only by pushing the target object 50 against the positioning body 80 without any consciousness, and thus the sticking work becomes easy. In the illustrated example, the positioning body 80 having a plate shape is laterally fixed to a lateral side of the contact position P3, and thus positioning of the target object 50 to the contact position P3 can be performed by pushing the target object 50 from a downward side to the positioning body 80.

(Aligner)

In this electronic tag sticking apparatus 1, the worker sticks the electronic tag 10 with the target object 50 held by hands, and even when the sticking position of the electronic tag 10 in the target object 50 can be freely adjusted by the worker, there is a concern that work of aligning the contact position P3 of the electronic tag 10 with a desired portion in the target object 50 becomes difficult without any guideline. Here, it is preferable that this electronic tag sticking apparatus 1 includes an aligner for aligning the contact position P3 of the electronic tag 10 with the desired portion in the target object 50. According to this, the work of aligning the contact position P3 of the electronic tag 10 with the desired portion in the target object 50 becomes easy. The aligner is not particularly limited, and may be set as a laser aligner 90 that irradiates a target position (for example, a part of the periphery of the contact position P3) of the contact position P3 with the electronic tag 10 in the target object 50 with laser light as illustrated in FIG. 13, FIG. 15, and FIG. 16.

(Control Unit)

The electronic tag sticking apparatus 1 includes a control unit (not illustrated) that performs communication with respective devices (the tag feeding device 20, the movement device 40, the tag holding part 30, and the like) or the detection device while performing input and output of information or arithmetic operation as necessary for operations, and controls the operations of the devices. Accordingly, the control unit can be set to include an input and output device, an arithmetic operation device, a communication device, a storage device, and the like. The control unit can be configured by using a known industrial control device such as a sequencer (PLC) and a computer (PC, a microcontroller) alone, or by combining a plurality of the control devices in correspondence with a function or the like.

### INDUSTRIAL APPLICABILITY

The invention can be used to stick an electronic tag having an adhesive part to a target object such as a product.

### REFERENCE SIGNS LIST

P1 Tag feeding position
P2 Standby position
P3 Contact position
VD Vertical direction
1 Electronic tag sticking apparatus
10 Electronic tag
10a, 10i Inlet
10a Antenna
10i IC chip
11 Adhesive part
12 Non-adhesive portion
13 Residual adhesive portion
20 Tag feeding device
30 Tag holding part
31 Rubber cup
32 Tag holding detection device
40 Movement device
41 Elevation cylinder
42 Lateral movement cylinder
50 Target object
60 Sticking detection device
70 Pedestal
80 Positioning body
90 Laser aligner
61 Target object detection device

1-6. (canceled)

7. An electronic tag sticking apparatus comprising:
a tag feeding device that feeds an electronic tag having an adhesive part to a predetermined tag feeding position;
a tag holding part that holds the electronic tag;
a movement device that moves the tag holding part to the tag feeding position, and a standby position of standing by sticking of the electronic tag; and
a sticking detection device that detects whether the electronic tag held by the tag holding part has been stuck to the target object held by a worker at a predetermined contact position,
wherein a preparatory operation of causing the tag holding part to locate at the tag feeding position by the movement device, causing the tag holding part to hold the electronic tag fed from the tag feeding device, causing the tag holding part holding the electronic tag to move to the standby position, and causing the adhesive part to stand by toward a pushing direction against a target object is performed, and
when detecting that the electronic tag has been stuck to the target object by the sticking detection device, after releasing the electronic tag from the tag holding part, the preparatory operation is performed.

8. The electronic tag sticking apparatus according to claim 7,
wherein a position of the electronic tag at the standby position is a contact position at which the electronic tag is stuck to the target object,
the sticking detection device detects that the target object has been disposed at the contact position, and
when detecting that the target object has been disposed at the contact position by the sticking detection device, the electronic tag is released from the tag holding part.

9. The electronic tag sticking apparatus according to claim 7,
wherein the position of the electronic tag at the standby position is spaced apart from a contact position at which the electronic tag is stuck to the target object,
a target object detection device that detects that the target object has been disposed at the contact position is provided,
the sticking detection device detects that the electronic tag has been moved to the contact position,
when detecting that the target object has been disposed at the contact position by the target object detection device, the tag holding part is moved by the movement device, and the electronic tag held by the tag holding part is moved to the contact position, and
when detecting that the electronic tag has been moved to the contact position by the sticking detection device, the electronic tag is released from the tag holding part.

10. The electronic tag sticking apparatus according to claim 7,
wherein a positioning body configured to push the target object to be positioned at the contact position is provided at the periphery of the contact position.

11. The electronic tag sticking apparatus according to claim 7, further comprising:
an aligner that aligns the contact position of the electronic tag with a desired portion in the target object.

12. The electronic tag sticking apparatus according to claim 7,
wherein the electronic tag is held by the tag holding part so that the adhesive part faces downward at the standby position and the contact position, and
the worker raises the target object from a lower side of the electronic tag to the contact position to perform sticking.
